(19) United States
(12) Patent Application Publication
(10) Pub. No.: US 2018/0096254 A1
(43) Pub. Date: Apr. 5, 2018

(54) PATENT DISPUTE FORECAST APPARATUS AND METHOD

(71) Applicant: KOREA INSTITUTE OF SCIENCE AND TECHNOLOGY INFORMATION, Daejeon (KR)

(72) Inventors: Jong Seok KANG, Goyang-si (KR); Sung Wha HONG, Seoul (KR); Hyuck Jai LEE, Seoul (KR); Hyun Sang CHUNG, Busan (KR); We SHIM, Seoul (KR)

(21) Appl. No.: 15/370,194

(22) Filed: Dec. 6, 2016

(30) Foreign Application Priority Data
Oct. 4, 2016 (KR) 10-2016-0127433

(51) Int. Cl. G06N 7/00; G06N 5/02

(52) U.S. Cl. CPC G06N 7/005; G06F 2216/11; G06N 5/02

(57) ABSTRACT

A patent dispute forecast apparatus and method. The patent dispute forecast apparatus includes a keyword extraction unit configured to extract keywords from the claims and backgrounds of a first patent document and a second patent document, a similarity calculation unit configured to calculate claim similarity and background art similarity between the first patent document and the second patent document using the extracted keywords, and a cooperative similarity calculation unit configured to calculate cooperative similarity by calculating the claim similarity and the background art similarity and to set the calculated cooperative similarity as an infringer identification probability value.

### CROSS REFERENCE TO RELATED APPLICATION

The present application claims the benefit of Korean Patent Application No. 10-2016-0127433 filed in the Korean Intellectual Property Office on Oct. 4, 2016, the entire contents of which are incorporated herein by reference.

### BACKGROUND OF THE INVENTION

### 1. Technical Field

The present invention relates to a patent dispute forecast apparatus and method and, more particularly, to a patent dispute forecast apparatus and method, wherein cooperation similarity is measured by independently calculating similarity using a text mining technology in the claims and background art of patent document and the measured cooperation similarity is set as an infringer identification probability value.

### 2. Description of Related Art

The value of intangible intellectual property rights, such as patent, is increasing daily. As may be seen from the smart phone suit between Samsung and Apple, the amount of compensation for damage attributable to patent infringement runs into astronomical figures.

Accordingly, a company has paid more attention to whether its product will conflict with or infringe on another's patent although its product will be commercialized, rather than patent search and analysis for reviewing novelty and inventiveness for filing a patent application.

However, many current patent search and analysis service providing companies, such as FOCUST, DELPHION, EUREKA, WIPSON, WINTELIPS and THOMSON REUTER, are providing only patent quantitative information analysis tools, such as patentability and patent trend analysis.

In a patent war era, patent disputes are suddenly increasing worldwide. In a conventional technology, dispute information about a patent dispute is simply databased and analyzed or such dispute occurrence information is simply transmitted through a news letter so that it can be searched for. However, such a service corresponds to a service for a patent dispute that was generated in the past, but does not provide forecast information about a dispute that will occur in the future.

Accordingly, a company, that is, the plaintiff or defendant of a dispute, has a different situation, product, technology and patent portfolio. There is an urgent need to introduce a service for providing dispute forecast information specified for such a company.

### PRIOR ART DOCUMENT

### Patent Document

Prior Art 1: Korean Patent Application Publication 2012-0046671 (May 10, 2012).

### SUMMARY OF THE INVENTION

Accordingly, the present invention has been made keeping in mind the above problems occurring in the prior art, and an object of the present invention is to provide a patent dispute forecast apparatus and method for extracting elements of patent document and forecasting a patent dispute possibility.

Technical objects of the present invention are not limited to the aforementioned object, and those skilled in the art will clearly understand other technological objects not described above from the following description.

In accordance with an aspect of the present invention, there is provided a patent dispute forecast apparatus, including a keyword extraction unit configured to extract keywords from the claims and backgrounds of a first patent document and a second patent document, a similarity calculation unit configured to calculate claim similarity and background art similarity between the first patent document and the second patent document using the extracted keywords, and a cooperative similarity calculation unit configured to calculate cooperative similarity by calculating the claim similarity and the background art similarity and to set the calculated cooperative similarity as an infringer identification probability value.

The similarity calculation unit may calculate the claim similarity between the elements of the claims of the first patent document and the elements of the claims of the second patent document based on All Element Rule.

Furthermore, the similarity calculation unit may calculate the background art similarity between the elements of the background art of the first patent document and the elements of the background art of the second patent document based on Doctrine of Equivalents.

The cooperative similarity calculation unit may calculate the cooperative similarity Sₕ using an equation below.

Sₕ=1−\sqrt{(1−S_{claim})²+(1−S_{background})²}

In this case, S_{claim} is the claim similarity, and S_{background} is the background art similarity.

Furthermore, the cooperative similarity calculation unit may calculate the cooperative similarity using an equation below.

$${S}_{h} = \sqrt{{( {S}_{claim} \cdot cos \frac{π}{4} )}^{2} + {( {S}_{background} \cdot sin \frac{π}{4} )}^{2}}$$

Furthermore, the cooperative similarity calculation unit may calculate the cooperative similarity using an equation below.

$$\begin{matrix}{S}_{h} = ρ \cdot {S}_{claim} + σ \cdot {S}_{background} \\ = ρ \cdot {S}_{claim} + ( 1 - ρ ) \cdot {S}_{background} \\ = ρ \cdot ( {S}_{claim} - {S}_{background} ) + {S}_{background}\end{matrix}$$

In this case, ρ is a specific constant, wherein “ρ+σ=1.”

In accordance with another aspect of the present invention, there is provided a patent dispute forecast method, including extracting, by a patent dispute forecast apparatus, keywords from claims and backgrounds of a first patent document and a second patent document, calculating, by the patent dispute forecast apparatus, claim similarity and background art similarity between the first patent document and the second patent document using the extracted keywords, and calculating, by the patent dispute forecast apparatus, cooperative similarity by calculating the claim similarity and the background art similarity and to set the calculated cooperative similarity as an infringer identification probability value.

The claim similarity between elements of the claims of the first patent document and elements of the claims of the second patent document may be calculated based on All Element Rule.

The background art similarity between the elements of the background art of the first patent document and the elements of the background art of the second patent document may be calculated based on Doctrine of Equivalents.

The patent dispute forecast method according to an embodiment of the present invention may be implemented in a program form and recorded on a recording medium readable by an electronic device or may be distributed through a program download management apparatus (e.g., a server).

### BRIEF DESCRIPTION OF THE DRAWINGS

FIG. 1 is a block diagram schematically showing the configuration of a patent dispute forecast apparatus according to an embodiment of the present invention.

FIG. 2 is a flowchart illustrating a patent dispute forecast method according to an embodiment of the present invention.

### DETAILED DESCRIPTION

The details of the objects and technological configurations of the present invention and corresponding advantages will become more clearly understood from the following detailed description based on the drawings accompanied by the specification of the present invention.

Hereinafter, a patent dispute forecast apparatus and method according to embodiments of the present invention are described in detail with reference to the exemplary drawings. The embodiments are provided so that those skilled in the art may easily understand the technological spirit of the present invention and the present invention is not restricted by the embodiments. Furthermore, contents represented in the accompanying drawings have been diagrammed in order to easily describe the embodiments of the present invention, and may be different from forms that are actually implemented.

Elements to be described herein are only examples for implementing the embodiments of the present invention. Accordingly, in other implementations of the present invention, different elements may be used without departing from the spirit and range of protection the present invention. Furthermore, each of the elements may be purely implemented using a hardware or software element, but may be implemented using a combination of various hardware and software elements that perform the same function.

Furthermore, an expression that some elements are “included” is an expression of an “open type”, and the expression simply denotes that the corresponding elements are present, but should not be construed as excluding additional elements.

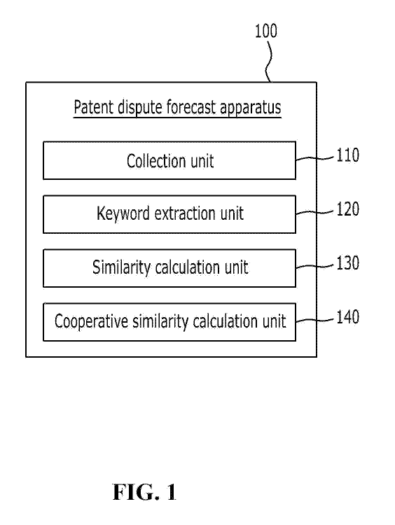

FIG. 1 is a block diagram schematically showing the configuration of a patent dispute forecast apparatus according to an embodiment of the present invention.

Referring to FIG. 1, the patent dispute forecast apparatus 100 includes a collection unit 110, a keyword extraction unit 120, a similarity calculation unit 130 and a cooperative similarity calculation unit 140.

The collection unit 110 collects patent documents from a server in which patent documents have been stored. The patent document may denote documents which have been made public or registered through patent offices. The collection unit 110 may collect patent documents from the patent office of each country and companies who provide patent documents.

The keyword extraction unit 120 extracts keywords from the backgrounds and claims of a first patent document and a second patent document. In this case, the first patent document may be an earlier application patent document, and the second patent document may be a subsequent application patent document.

The keyword extraction unit 120 extracts a keyword set for the patent information (i.e., the claims and the background art) in each patent document in accordance with a predetermined method. The keyword set may be extracted using a variety of pieces of patent information in addition to the claims and the background art. In this specification, it is assumed that the keyword set is extracted using the claims and the background art, for convenience of understanding and description. For example, the keyword set may be extracted using an association rule algorithm. The association rule algorithm may be any one of Apriori Algorithm, AprioriTID Algorithm, AprioriHybrid Algorithm and DHP Algorithm. The association rule algorithm is evident to those skilled in the art, and a separate description thereof is omitted. Furthermore, the keyword set may be extracted differently depending on a setting condition. In this case, the setting condition may include any one of a sentence unit and a paragraph unit.

If the setting condition is a sentence unit, each claim of each patent document is extracted as the keyword set in a basic unit. In contrast, if the setting condition is a paragraph unit, claims are separated and extracted as the keyword set according to a predetermined symbol (e.g., a comma, a semicolon or a colon) within each claim. Furthermore, the keyword set may be extracted in a word unit or may be extracted in a phrase unit. A method for extracting the keyword set using the association rule algorithm is evident to those skilled in the art, and a detailed method thereof is omitted.

The similarity calculation unit 130 calculates claim similarity S_{claim} and background art similarity S_{background} between the first patent document and the second patent document using the keyword extracted by the keyword extraction unit 120.

That is, the similarity calculation unit 130 calculates the claim similarity between the elements of the claims of the first patent document and the elements of the claims of the second patent document based on All Element Rule. Furthermore, the similarity calculation unit 130 calculates the background art similarity between the elements of the background art of the first patent document and the elements of the background art of the second patent document according to Doctrine of Equivalents. In this case, the similarity calculation unit 130 may calculate the claim similarity or the background art similarity using various methods, such as a clustering scheme, a cosine basis, a correlation basis, and an adaptive cosine basis.

The cooperative similarity calculation unit 140 calculates cooperative similarity by calculating the claim similarity and background art similarity calculated by the similarity calculation unit 130 and sets the calculated cooperative similarity Sₕ as an infringer identification probability value. The infringer identification probability means a probability that the patent documents of an earlier application (or applicant) and a subsequent application (or applicant) form a point of contact in the boundary surface of the same product area and the counterpart will be identified through mutual monitoring.

The cooperative similarity calculation unit 140 calculates the cooperative similarity Sₕ using Equation 1.

Sₕ=1−\sqrt{(1−S_{claim})²+(1−S_{background})²} (1)

In Equation 1, S_{claim} may be the claim similarity, and S_{background} may be the background art similarity.

Furthermore, the cooperative similarity calculation unit 140 may calculate the cooperative similarity using Equation 2.

$${S}_{h} = \sqrt{{( {S}_{claim} \cdot cos \frac{π}{4} )}^{2} + {( {S}_{background} \cdot sin \frac{π}{4} )}^{2}} \qquad ( 2 )$$

Furthermore, the cooperative similarity calculation unit 140 may calculate the cooperative similarity using Equation 3.

$$\begin{matrix}{S}_{h} = ρ \cdot {S}_{claim} + σ \cdot {S}_{background} \\ = ρ \cdot {S}_{claim} + ( 1 - ρ ) \cdot {S}_{background} \\ = ρ \cdot ( {S}_{claim} - {S}_{background} ) + {S}_{background}\end{matrix} \qquad ( 3 )$$

In Equation 3, ρ is a negotiation power and may be a specific constant, wherein “ρ+σ=1.”

Each of the collection unit 110, the keyword extraction unit 120, the similarity calculation unit 130 and the cooperative similarity calculation unit 140 may be implemented by a processor necessary to execute a program on a computing device. As described above, the collection unit 110, the keyword extraction unit 120, the similarity calculation unit 130 and the cooperative similarity calculation unit 140 may be implemented by respective elements that are physically independent or may be implemented in a form in which they are functionally separated in a single processor.

The patent dispute forecast apparatus 100 may include at least one piece of operation means and storage means. In this case, the operation means may be a central processing unit (CPU), but may be programmable device elements (e.g., CPLD or FPGA) or application-specific semiconductor circuits (ASIC) implemented suitably for a specific purpose. The storage means may be a volatile memory device, a non-volatile memory device or a non-volatile electromagnetic storage device.

The patent dispute forecast apparatus 100 may include various devices, such as a PC, a navigator, a notebook, a mobile terminal, a smart phone, a portable media player (PMP), a personal digital assistant (PDA), a tablet PC, a set-top box and smart TV.

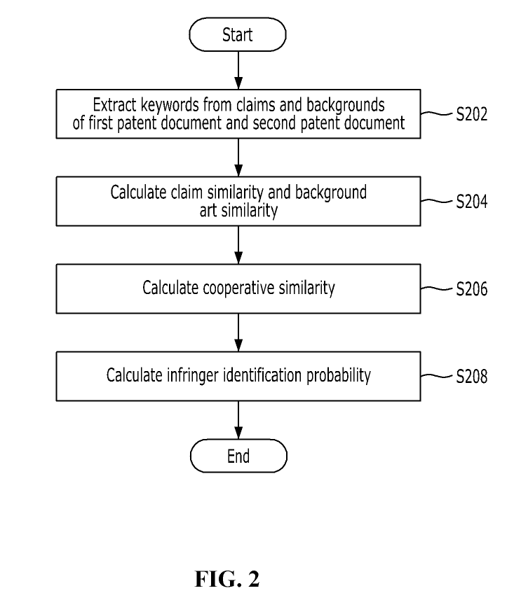

FIG. 2 is a flowchart illustrating a patent dispute forecast method according to an embodiment of the present invention.

Referring to FIG. 2, the patent dispute forecast apparatus extracts keywords the backgrounds and claims of a first patent document and a second patent document at step S202.

Thereafter, the patent dispute forecast apparatus calculates claim similarity and background art similarity using the extracted keywords in the first patent document and the second patent document at step S204, and calculates cooperative similarity by calculating the claim similarity and the background art similarity at step S206. That is, the patent dispute forecast apparatus calculates the claim similarity between the elements of the claims of the first patent document and the elements of the claims of the second patent document based on All Element Rule. Furthermore, the patent dispute forecast apparatus calculates the background art similarity between the elements of the background art of the first patent document and the elements of the background art of the second patent document based on Doctrine of Equivalents.

Thereafter, the patent dispute forecast apparatus sets the calculated cooperative similarity as an infringer identification probability at step S208.

A method for calculating, by the patent dispute forecast apparatus, the infringer identification probability has been described above with reference to FIG. 1.

In accordance with an embodiment of the present invention, cooperation similarity is measured by independently calculating similarity using a text mining technology in the background art and claims of patent document. Accordingly, a patent dispute possibility can be forecast.

Advantages of the present invention are not limited to the aforementioned advantages and may include various other advantages within a range evident to those skilled in the art from the following description.

As described above, those skilled in the art to which the present invention pertains will appreciate that the present invention may be implemented in other detailed forms without changing the technological spirit or essential characteristics of the present invention. Accordingly, it is to be understood that the aforementioned embodiments are only illustrative and are not limiting. It is also to be noted that the illustrated flowchart is merely sequential order illustrated to achieve the most preferred results in implementing the present invention, and other additional steps may be provided or some of the steps may be deleted.

The technological characteristics described in this specification and an implementation for executing the technological characteristics may be implemented using a digital electronic circuit, may be implemented using computer software, firmware or hardware including the structure described in this specification and a structural equivalent thereof or may be implemented by a combination of one or more of them. Furthermore, the implementation for executing the technological characteristics described in this specification may be implemented in the form of a computer program product, that is, a module regarding computer program instructions encoded on a kind of program storage media in order to control the operation of a processing system or for execution by the processing system.

In this specification, the term “apparatus” covers all of apparatuses, devices, and machines for processing data, for example, including a processor, a computer and a multi-processor or a computer. The processing system may include all types of code that form an execution environment for a computer program upon request, such as code, a protocol stack, a database management system, an operating system and a combination of one or more of them that form processor firmware, in addition to hardware. A computer program also known as a program, software, a software application, a script or code may be written in any form of a programming language including a compiled or interpreted language or a transcendental and/or procedural language, and may also be implemented in any form including an independent program, module, a component, a subroutine or other units suitable for being used in a computer environment.

The elements for executing the technological characteristics of the present invention included in the block diagram and flowchart shown in the accompanying drawings of this specification mean the logical boundary between the elements. In accordance with a software or hardware embodiment, however, the illustrated elements and functions thereof are executed in the form of an independent software module, a monolithic software structure, code, a service or a combination of them and are stored in a medium executable by a computer including a processor capable of executing stored program code and instructions, and the functions of the illustrated elements may be implemented. Accordingly, all of such embodiments should be construed as belonging to the range of right of the present invention. Accordingly, the accompanying drawings and technologies thereof describe the technological characteristics of the present invention, but should not be simply reasoned unless a specific array of software for implementing such technological characteristics is clearly described otherwise. That is, various other embodiments may be present and may be partially modified while having the same technological characteristics as those of the present invention. Accordingly, such modified embodiments should be construed as belonging to the range of right of the present invention. Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous. Furthermore, the separation of various system components in the aforementioned embodiments should not be construed as being requested in all of the embodiments. It should be understood that the aforementioned program components and systems may be integrated into a single software product or packaged into a multi-software product.

As described above, this specification is not intended to limit the present invention by the proposed detailed terms. Accordingly, although the present invention has been described in detail in connection with the aforementioned embodiments, a person having ordinary skill in the art to which the present invention pertains may alter, change, and modify the embodiments without departing from the range of right of the present invention. Accordingly, the range of right of the present invention is defined by the appended claims rather than the detailed description, and the present invention should be construed as covering all of modifications or variations derived from the meaning and scope of the appended claims and equivalents thereof.

What is claimed is:

1. A patent dispute forecast apparatus, comprising:
a keyword extraction unit configured to extract keywords from claims and backgrounds of a first patent document and a second patent document;
a similarity calculation unit configured to calculate claim similarity and background art similarity between the first patent document and the second patent document using the extracted keywords; and
a cooperative similarity calculation unit configured to calculate cooperative similarity by calculating the claim similarity and the background art similarity and to set the calculated cooperative similarity as an infringer identification probability value.

2. The patent dispute forecast apparatus of claim 1, wherein the similarity calculation unit calculates the claim similarity between elements of the claims of the first patent document and elements of the claims of the second patent document based on All Element Rule.

3. The patent dispute forecast apparatus of claim 1, wherein the similarity calculation unit calculates the background art similarity between elements of the background art of the first patent document and elements of the background art of the second patent document based on Doctrine of Equivalents.

4. The patent dispute forecast apparatus of claim 1, wherein the cooperative similarity calculation unit calculates the cooperative similarity Sₕ using an equation below.
Sₕ=1−\sqrt{(1−S_{claim})²+(1−S_{background})²}
wherein S_{claim} is the claim similarity, and S_{background} is the background art similarity.

5. The patent dispute forecast apparatus of claim 1, wherein the cooperative similarity calculation unit calculates the cooperative similarity using an equation below.
$${S}_{h} = \sqrt{{( {S}_{claim} \cdot cos \frac{π}{4} )}^{2} + {( {S}_{background} \cdot sin \frac{π}{4} )}^{2}}$$

6. The patent dispute forecast apparatus of claim 1, wherein the cooperative similarity calculation unit calculates the cooperative similarity using an equation below.
$$\begin{matrix}{S}_{h} = ρ \cdot {S}_{claim} + σ \cdot {S}_{background} \\ = ρ \cdot {S}_{claim} + ( 1 - ρ ) \cdot {S}_{background} \\ = ρ \cdot ( {S}_{claim} - {S}_{background} ) + {S}_{background}\end{matrix}$$
wherein ρ is a specific constant, wherein “ρ+σ=1.”

7. A patent dispute forecast method, comprising:
extracting, by a patent dispute forecast apparatus, keywords from claims and backgrounds of a first patent document and a second patent document;
calculating, by the patent dispute forecast apparatus, claim similarity and background art similarity between the first patent document and the second patent document using the extracted keywords; and
calculating, by the patent dispute forecast apparatus, cooperative similarity by calculating the claim similarity and the background art similarity and to set the calculated cooperative similarity as an infringer identification probability value.

8. The patent dispute forecast method of claim 7, wherein the claim similarity between elements of the claims of the first patent document and elements of the claims of the second patent document is calculated based on All Element Rule.

9. The patent dispute forecast method of claim 7, wherein the background art similarity between elements of the background art of the first patent document and elements of the background art of the second patent document is calculated based on Doctrine of Equivalents.

10. The patent dispute forecast method of claim 7, wherein the cooperative similarity Sₕ is calculated using an equation below.
Sₕ=1−\sqrt{(1−S_{claim})²+(1−S_{background})²}
wherein S_{claim} is the claim similarity, and S_{background} is the background art similarity.

11. The patent dispute forecast method of claim 7, wherein the cooperative similarity is calculated using an equation below.
$${S}_{h} = \sqrt{{( {S}_{claim} \cdot cos \frac{π}{4} )}^{2} + {( {S}_{background} \cdot sin \frac{π}{4} )}^{2}}$$

12. The patent dispute forecast method of claim 7, wherein the cooperative similarity is calculated using an equation below.
$$\begin{matrix}{S}_{h} = ρ \cdot {S}_{claim} + σ \cdot {S}_{background} \\ = ρ \cdot {S}_{claim} + ( 1 - ρ ) \cdot {S}_{background} \\ = ρ \cdot ( {S}_{claim} - {S}_{background} ) + {S}_{background}\end{matrix}$$
wherein ρ is a specific constant, wherein “ρ+α=1.”

13. A computer-readable recording medium on which a program for executing the patent dispute forecast method according to claim 7 has been recorded.

14. A computer-readable recording medium on which a program for executing the patent dispute forecast method according to claim 8 has been recorded.

15. A computer-readable recording medium on which a program for executing the patent dispute forecast method according to claim 9 has been recorded.

16. A computer-readable recording medium on which a program for executing the patent dispute forecast method according to claim 10 has been recorded.

17. A computer-readable recording medium on which a program for executing the patent dispute forecast method according to claim 11 has been recorded.

18. A computer-readable recording medium on which a program for executing the patent dispute forecast method according to claim 12 has been recorded.
